(19) United States
(12) Patent Application Publication
(10) Pub. No.: US 2008/0182747 A1
(43) Pub. Date: Jul. 31, 2008

(54) Special formulations for the removal of mercury and other pollutants present in combustion gases

(76) Inventor: Rabindra K. Sinha, McKees Rocks, PA (US)

Correspondence Address: Rabindra K. Sinha, 609 Hancock Ct., McKees Rocks, PA, 15136, US

(21) Appl. No.: 11/657,741

(22) Filed: Jan. 25, 2007

(51) Int. Cl. B01J 20/04

(52) U.S. Cl. 502/400

(57) ABSTRACT

The invention provides compositions to remove mercury and other pollutants from a fluid stream, particularly flue gases containing them. The compositions are mixtures of compounds selected from two or more different groups of compounds. One of the compositions can simultaneously remove mercury and condition the dust for better removal of the dust by an ESP if an ESP is the device of choice for dust control. This composition is a mixture selected from the group of halides other than fluoride and chloride, and mixture thereof, and that selected from a group of nitrates. In the other invention, the composition consists of a mixture of selected polyhydroxy compound or compounds, ammonium sulfate, halides other than fluoride and chloride, and mixture thereof. The composition can be liquid or dry powder and can be injected ahead of the particulate control device as a mist when the formulation is a liquid or as a powder when dry. Methods are provided for applying the formulations.

### BACKGROUND OF THE INVENTION

This invention relates to special formulations having the properties of removing mercury and other pollutants from gas streams containing these pollutants, particularly when the mercury and other pollutants are contained in the combustion gases of fossil fuels such as coal, lignite, peat, fuel oil, and derived fuels such as municipal and industrial wastes and refuge.

Environmental considerations require that emissions of hazardous pollutants such as mercury and dioxin be contained. Most US coals and municipal refuge contain mercury in them which is released in the form of elemental and oxidized mercury with the combustion gases. Dioxin is generally produced during the combustion process from the precursor components present in the fossil or derived fuels. Unless the mercury and the precursors leading to the formation of dioxin are removed from the fuel prior to its combustion, they become a component of the gases produced by the combustion of the fuel and become extremely difficult to remove effectively and economically by known processes.

Coal (a term utilized in here to describe solid fuels such as bituminous and sub-bituminous coals, anthracite, lignite and peat) is one of the most important fuels for producing power. It is burned in boilers all over the world to produce steam and electrical power. Power plants in the USA is estimated to burn more than one billion tons of coal a year.

Coals contain many impurities including ash, sulfur, mercury, arsenic, selenium, beryllium, boron, etc. When coal is burned in a furnace it is converted to carbon dioxide and water producing heat. The impurity such as ash remains behind as a residue while the majority of other impurities such as sulfur, mercury, arsenic, etc. leave with the combustion gases, also known as flue gases.

Depending upon the firing practices utilized, the ash is removed as bottom ash or as a combination of bottom and fly ash. The fly ash is that portion of the ash that becomes entrained in the combustion gases and moves around with them into the various parts of the boiler or combustion systems. Since the ash is entrained with the combustion gases, it is removed from the combustion gases before the gases are discharged into the atmosphere through chimneys or stacks. The separation of the entrained or the fly ash from the combustion gases is accomplished by utilizing particulate control devices such as cyclones, electrostatic precipitators, bag houses or their combinations. Coal ash in itself is regarded as a pollutant as it can contribute to the particulate matter considered unhealthy such as PM 10 and PM 2.5.

Emissions of mercury from power plants, though minuscule in mass compared to ash and oxides of sulfur and nitrogen commonly referred to SOx and NOx, are targeted for control due to its tendency to bio-accumulate, and its potency as a neurotoxin.

The mercury is emitted from the stacks with the combustion gases in the form of elemental and oxidized mercury. The ratio between the elemental and the oxidized forms depends upon the type of the coal being burned and the equipment it is burned in. The ratio of the oxidized to the elemental (unoxidized) form of mercury when burning bituminous or Eastern coals is higher than when burning sub-bituminous or Western coals. The higher ratio when burning bituminous coals is believed due to the presence of a higher level of chlorides in the bituminous than sub-bituminous coals.

Many novel and unique methods are currently being evaluated to control the emission of mercury from the stack gases. Most of the processes require injection of a mercury specific sorbent(s) into the combustion gas stream The sorbent is injected prior to the particulate control device(s) so that the sorbent containing the adsorbed mercury is removed by the particulate control device(s) together with the fly ash.

Among the sorbents tried have been powdered activated carbon, powdered activated carbon containing an impregnant such as iodine, bromine, sulfur, etc., various chars, clays, zeolites, different types of fly ash, fly ash enriched with unburned carbon, etc. However, in the USA, as it is practiced commercially in the countries of Europe and Asia, powdered activated carbon is one of the most effective sorbents for mercury removal. The powder activated carbon is blown in by compressed air into the combustion gases upstream of the particulate control device where the gaseous temperature, depending on the particulate control device type, ranges between 250 and 800° F. In the case of cold side electrostatic precipitators and bag houses the temperatures range is between 250 and 400° F. The hot side electrostatic precipitators operate around 800° F. The powder carbon works best when the gas temperatures are low and for that reason even in the cold side applications, sometimes, the flue gases are cooled by injecting a fine spray of water.

Sometimes, the carbon is specially modified by adding sulfur, iodine, chloride, etc. to make it more suitable to remove the mercuric form of mercury. Such specificity is introduced in the carbon either during its manufacturing or as a separate step after the carbon has been manufactured.

The ineffectiveness of carbon at high temperatures requiring gas cooling and incorporation of specificity by way of special impregnants to the carbon adds to the overall cost of mercury removal. In addition, the costs of activated carbons in itself is a major factor in keeping the mercury removal costs unacceptable. Further, injected activated carbon destroys the pozzolanic properties of Western coal ash, sale of which in itself is a good revenue generator to Western coal users. Not only the ash can't be sold it also now has to be disposed adding an additional cost to the utilities. A technology is needed that is simple and less expensive to use than activated carbon and other expensive technologies.

Unlike the aforementioned methods of mercury control, use of the compositions of the present invention provides an effective, efficient, and low cost means for controlling mercury and other pollutant emissions with very little limitations. The formulations when injected in the liquid form can produce very fine mist as it evaporates during its travel towards the particulate control device. The formulation is expected to become much finer than pulverized activated carbons and thus much better distributed in the gas stream than the injected pulverized carbons. The formulations as described herein are much more effective than powdered carbon. Moreover, use of these invented compositions fills an important need by reducing several emissions simultaneously from flue and process gases from the combustion of fossil or derived fuels. Because of these desirable characteristics, the present invention constitutes a significant advancement over prior control arts.

### SUMMARY OF THE INVENTION

The present invention provides compositions and methods for maintaining and generating active compositions in the flue gas, upstream of the particulate control device, that are effective in removing the flue gas borne pollutants such as mercury, dioxin, fine particulate ash, etc. The pollutant laden composition is removed by the particulate control device together with the fly ash generated by the combustion of pollutant and ash bearing fuels.

The composition can be a liquid, if all the selected components are liquid at room temperatures or by dissolving them in a common solvent such as water, if soluble. It can also be a dry mixture of finely ground powders, if the components of the composition are solid at room temperatures, either by themselves or as a mixture with other powder diluents such as fly ash, clays including vermiculite, exfoliated or not, silica, alumina, zirconia, etc. The composition can also be made into a powder should any of the components selected be available as a liquid at room temperatures by mixing the liquid components with one or a mixture of diluent powders selected from the group of fly ash, clays including vermiculite, exfoliated or not, silica, alumina, zirconia, etc.

The compositions as invented herein are added to the flue gas at a minimum temperature of 200° F. In one invented formulation it consists of a mixture of nitrate of ammonia, alkali, alkaline and base metals, and iodide and bromide of ammonia, alkali and alkaline metals, or mixtures thereof. In another invented composition it consists of a polyhydroxy compound selected from the group of glycerin, fructose, sucrose, sugar, Maltose, Whey, cellulose and starch and bromide of ammonia, alkali and alkaline metals, or mixtures thereof. The polyhydroxy compound, in the second invented formulation, provides the source for the sorbent generation, that is, it serves the purpose of being a sorbent precursor. Any of the formulations disclosed herein is injected into the flue gas as a dry powder or when all components are soluble in a common solvent, then as a solution.

Injection of the invented composition in the form of a fine powder is facilitated by mixing the selected components of the composition as individual powders or when any of the components is a liquid then thoroughly mixing the said liquid component with an inert material such as powdered clays, alumina, silica, coal ash etc., or mixtures thereof to make it a free flowing powder and blowing the said powder into the flue gas stream. When all the components are available as solid powders at room temperatures, the composition can be mixed with other powders such as fly ash, clays, exfoliated or not, silica, etc., as diluents for the improved ease of injection and dosage control. A number of variations and modifications of the invention can be used. It would be possible to provide for some features of the invention without providing others.

For example in one alternative embodiment though the invention has been described above with reference to removing mercury, it can also be utilized, particularly formulation 1, containing the disclosed nitrates and bromides or iodides to condition the flue gas for improved electrostatic precipitator performance. Thus this formulation can be utilized to remove mercury as well as to condition the ash for opacity control.

### DETAILED DESCRIPTION OF THE INVENTION

The compositions of the invention comprise a mixture of the water soluble or the dry powder form of compounds selected from the group of ammonium nitrate, lithium nitrate, sodium nitrate, ferric nitrate, aluminum nitrate and other nitrates that decompose at temperatures below 800° F., ARKAY Tech ATI-2001, a polyhydroxy compound such as glycerin, sucrose glucose, fructose, molasses, lactose, whey, cellulose, starches or their derivatives and one or more iodides and bromides selected from the group of ammonium, alkali, alkaline and base metals. When used as a dry powder, the formulation may be mixed with fly ash, clays such as bentonite, vermiculite, etc., silica, alumina, titania or zirconia either as an extender or to make the formulation more free flowing and easy to monitor and control the dosage of the formulation.

The composition, when in the liquid form, either because of all the selected components are available as liquids at room temperature or because the components are soluble in an inert solvent such as water, can be injected into the gas stream as a fine mist. The injection as a fine mist can be accomplished by utilizing devices common for generating mist out of a liquid formulation. For example, the liquid can be atomized by utilizing high mechanical shearing such as those produced by forcing the liquid, under pressure, through fine hole nozzles or by utilizing dual fluid nozzles where the liquid (fluid I) is atomized by compressed fluid (fluid II), for example air, steam or other gas.

When the components selected in making the formulation is available as solids, they can be ground separately or in combination, if suitable, to a fine powder and injected/blown into the gas stream at appropriate temperatures prior to the particulate collection device(s) by a suitable vehicle such as compressed air. The liquid components of the composition can also be made into a powder by mixing them separately or in combination with other dry powders such as fly ash, clays, silica, alumina, etc.

The solid components can also be made into a powder and mixed with diluents such as fly ash, clays, silica, etc., either individually, in combination or the mixture of the formulation and the selected diluents ground into a fine powder before injecting/blowing them into the gas streams.

Many variations of the above techniques, which by no means should be construed as restricting to making or using the formulation can be obvious to those trained in the art of making and using liquid or solid (powder) formulations.

### EXAMPLES

The following examples further demonstrate the instant invention. These examples should not, however, be construed as limiting the instant invention in any way.

### Example 1

Various formulations containing compositions of the invention and others were prepared in the laboratory as follows:
SAMPLE I: 2 grams of ammonium bromide, 2 grams of sodium bromide and 2 grams of potassium iodide were dissolved in 94 grams of water to produce a clear solution.
SAMPLE II: To 94 grams of an aqueous solution containing 40% ammonium nitrate, 5% sodium nitrate and 1% Lithium nitrate, 2 grams of ammonium bromide, 2 grams of sodium bromide and 2 grams of potassium bromide was added to make a solution.
SAMPLE III: To 96 grams of ATI-2001, a commercial product available from ARKAY Technologies, Inc., 609 Hancock Ct, McKees Rocks, Pa. 15136, 2 grams of ammonium bromide, 2 grams of sodium bromide and 2 grams of sodium iodide was added and stirred until fully dissolved.
SAMPLE IV: To 94 grams of ATI-2001, a commercial product available from ARKAY Technologies, Inc., 609 Hancock Ct., McKees Rocks, Pa. 15136, 2 grams of potassium iodide, 2 grams of potassium bromide and 2 grams of sodium bromide was added and made into a solution.
SAMPLE V: To 94 grams of ATI-2001, a commercial product available from ARKAY Technologies, Inc., 609 Hancock Ct., McKees Rocks, Pa. 15136, 2 grams of ammonium bromide, 2 grams of sodium bromide and 2 grams of potassium bromide were added to make a solution.
SAMPLE VI: To 98 grams of an aqueous solution containing 40% ammonium nitrate, 5% sodium nitrate and 1% Lithium nitrate, 2 grams of sodium iodide was added to make a solution.
SAMPLE VII: An aqueous solution containing 30% sucrose (by dissolving Domino brand granular sugar), 15% ammonium sulfate, 2% potassium iodide and 2% potassium bromide was made by dissolving appropriate amounts of the above selected components.
SAMPLE VIII: An aqueous solution containing 30% sucrose (Domino brand granular sugar), 15% ammonium sulfate, 2% ammonium bromide, 2% sodium bromide and 2% potassium bromide was made by dissolving appropriate amounts of the components mentioned above.

In order to evaluate the performance of the above preparations a simple test as described below was conducted in the lab. with the above preparations.
Laboratory Test Procedures: 5 grams of the preparation (any) was mixed with 20 grams of water. A globule of metallic mercury (taken from a pool of mercury which was first washed with dilute nitric acid and then with water for several times until the pH leveled to that of the wash water, or above 6 units) was added to each solution and heated to boiling for 2 minutes, cooled and volume made-up to 25 ml. The liquid was filtered, leaving the undissolved mercury globule behind, on the filter paper. 5 gm of the filtered solution was mixed thoroughly into a paste with 25 grams of minus 100 mesh fly ash from a Midwest utility burning Powder River Basin Coal. The paste was air dried, crushed and submitted for total mercury analysis.

All samples that contained sucrose in it, that is samples VII and VII, became extremely dark and some particulate char separated from it. Charring was expected (see U.S. Pat. # 7,081,434 B 2). The charred sample was filtered, 5 gram mixed with 25 gram fly ash, air dried, crushed and submitted for mercury analysis.

A blank was also prepared by following the above procedures except only water (without any of the above preparation) and a globule of mercury was heated to boiling for 2 minutes, cooled, made to 25 ml, filtered, made into a paste by mixing 5 grams with 25 grams of fly ash, air dried, and crushed.

The results of mercury analysis are presented in Table 1 below:

TABLE 1
Levels of mercury in the prepared ash

| Sample Type | Mercury Level (dry basis) | |
|---|---|---|
| Baseline (two sets) | ND, 0.05 | ug/kg |
| With Sample I | ND | |
| With sample II | 0.83 | ug/kg |
| With Sample III | 0.69 | ug/kg |
| With Sample IV | 0.66 | ug/kg |
| With Sample V | 0.79 | ug/kg |
| With Sample VI | 0.53 | ug/kg |
| With Sample VII | ND | ug/kg |
| With Sample VIII | ND | ug/kg |

ND = Not Detected, below 0.03 ug/kg
ug/kg = microgram of mercury/kilo gram of ash

Analytical data presented in Table 1 above shows that the preparations containing only the halides (bromide and iodide; sample I) was ineffective in extracting any mercury into the aqueous solution and so was the blank (with water alone). The preparations containing the halides and the nitrates (samples H through VI) were quite effective in extracting the mercury as evidenced by higher numbers of mercury level present in the ash. The sugar containing preparations (samples VII & VIII) were also not effective in extracting the mercury. It would be expected as any char produced from the carbonization of sugar would have adsorbed any soluble mercury and was thus filtered out. Based on the results of sample I, had charring not occurred even then it is not expected that any mercury could have been solublized by these treatments.

### Example 2

A field test was conducted with formulations similar in composition to Samples V and VIII described above. The field tests were conducted on units burning Powder River Basin Coals. One field unit utilized an electrostatic precipitator to control the particulate emission. For simplicity we shall identify it as Unit 1. The other tested unit utilized a bag house for particulate control. We shall call it Unit 2.

Unit 1 is a tangentially fired, dry bottom about 360 MW boiler burning Powder River Basin coal. The particulate control device is a set of to parallel electrostatic precipitators with a total SCA of about 240 ft²/1000 ACFM. The flue gas leaves the stack at around 330° F. The gases leaving the air-preheaters (2) from the boiler are led to two parallel precipitator houses through two ID fans before they are discharged through a common stack. The ESP performances are constantly monitored by their power levels and instantaneous and six minute average opacities. ATI-2001, an ash conditioner, commercially available from ARKAY Technologies, Inc., 609 Hancock Court, McKees Rocks, Pa. 15136, is utilized on this unit to keep the opacity within plant's goal of less than 15% computed on the basis of six minute averages.

The fly ash conditioning chemical, ATI-2001, diluted in-line with plant water is added to each duct in the form of an atomized mist through two fluid nozzles. Compressed air is utilized as the atomizing fluid. The chemical to each lance/nozzle system is metered through a diaphragm pump and the feed rate to each lance/nozzle system is controlled automatically by an algorithms tied to the power level of the ESP box.

Unit 2 is also tangentially fired, dry bottom, about 360 MW boiler using Powder River Basin coal. The particulate control devices in this case are two parallel bag houses with an air to cloth ratio of 3.17 to 1. The stack gas temperature is also around 330° F. The combustion gases leaving the rotary air pre-heaters (2) are led in two ducts to each bag house box, pulled by two individual ID fans before being discharged through a common stack.

The test for mercury removal on Unit 1 (with the ESP) was conducted with the test chemicals on one half of the unit. The tested chemical was fed to one half of the unit utilizing the same feed system and feed locations as the fly ash conditioning chemical (ATI-2001).

EPA test protocol EPA 324 was utilized to monitor the levels of mercury in the combustion gases before treatment and with treatment In the case of Unit 1 (with the ESP) the gases leaving the ID fan on the side selected for the treatment was utilized to monitor the mercury levels. In the case of Unit 2 (with the Bag houses), the duct after the bag house on the side selected for the treatment was utilized to monitor the mercury levels. The Frontier Geosciences (of Seattle, Wash.) continuous gas sampler was utilized to monitor the mercury levels in the gas stream. The results of the test are presented in Tables 2 and 3 below.

TABLE 2
Mercury Test Results on Unit 1 (with ESP system)

| | Flow Rate of | Total Mercury; | % Hg |
|---|---|---|---|
| Test Chemical | Test Chemical | ng/liter (std) | Removed |
| None (blank/ | None | 8.33 | NA |
| baseline) | | | |
| ATI-2001 | 1 unit gallon per hour | 6.33 | 24.1 |
| X 1 (similar to | 1 unit gallon per hour | 2.39 | 71.3 |
| Sample V) | | | |
| X 2 (similar to VIII) | 1 unit gallon per hour | 7.63 | 8.4 |

NA = Not applicable;
ng/liter = nano gram of mercury per standard liter of gas sampled.

TABLE 3
Mercury Test Results on Unit 2 (with Bag house)

| | Flow Rate of | Total Mercury; | % Hg |
|---|---|---|---|
| Test Chemical | Test Chemical | ng/liter (std) | Removed |
| None (blank) | None | 4.21 | NA |
| X 1 (similar to | <0.5 unit gallon per hour | 2.08 | 50.6 |
| Sample V) | | | |
| X 2 (similar to | <0.5 unit gallon per hour | 2.11 | 49.9 |
| VIII) | | | |

NA = Not Applicable;
ng/liter = nano gram of mercury per standard liter (of gas volume)

The test results as presented in Tables 2 and 3 will show to those familiar in the arts and sciences of result interpretation that the selected test formulations are effective in removing mercury from flue gases derived from coal fired boilers, irrespective of whether the boiler is fitted with an ESP or a bag house for particulate control.

The effectiveness of X 1 for controlling opacity on Unit 1 was also evaluated. The test results on opacity and ESP power levels are presented in Table 4 below. The table show that the ESP power levels compared to the “blank or baseline” increased substantially and the stack opacity, which reflects the operation of the whole unit, not the half which is treated, also decreased. For the sake of brevity, only a few data points are shown for comparison purposes.

The “baseline” data in Table 4 is when no chemical is fed (on one half of the unit), the “normal” operation is for the condition when the unit is conditioned with ATI-2001 where the feed rate is controlled electronically by an “auto mode”, and Merc X-1 and ATI-2001 are fed manually at one unit gallon per hour.

TABLE 4
ESP Power and Opacity Data with Various Treatments

| | | ESP Power | Opacity |
|---|---|---|---|
| Treatment Chemical | Feed Rate | (Half Unit) | (Full Unit) |
| None (Baseline) | None | 25–80 KW | 15–17% |
| ATI-2001 | Normal (Auto) | 110–160 KW | 14–15% |
| ATI-2001 | 1 Unit Gallon per hour | 200–280 KW | 12–13% |
| Merc X-1 | 1 Unit Gallon per hour | 160–180 KW | 14–16% |

To those familiar in the arts and sciences of interpreting data, it is clear from Table 4 that the treatment chemical Merc X 1 containing ammonium bromide, sodium bromide and potassium bromide and ammonium nitrate, sodium nitrate, lithium nitrate, in water is capable of conditioning the fly ash as evidenced by its capability to raise the ESP power and lower the opacity levels over no treatment (blank/baseline) or auto treatment conditions.

I have thus demonstrated by laboratory and field tests that the formulations disclosed in here can be prepared with material easily available in the marketplace and are capable of removing mercury from flue gases and should one desire to also condition the fly ash to improve ESP performance in addition to mercury removal then the appropriate formulation can be selected from those disclosed here in.

### Method of Use

The composition of the invention can be added to the flue or process gas streams at temperatures between 200 and 800° F. but prior to the particulate control/collection device or devices. It is preferred to add/inject the liquid or solution form of the formulation to the gas stream as a fine mist utilizing one or combinations of several methods known for atomizing a liquid stream. For example, a dual fluid nozzle mounted on appropriate lance and delivery system can be utilized to inject the liquid formulation as a fine mist. When utilizing a dual fluid nozzle, compressed air or steam can be used as the second fluid for atomizing the formulation. The formulation can be diluted with inert solvents, for example water when the individual components of the invention are water soluble, to assist the atomization and to improve the fineness of the mist particle size.

The powder form of the invention, when the components are available as dry solids at room temperatures, either by itself or when mixed with other powdery materials such as fly ash, clays, silica, alumina, etc., or when made into a powder by mixing the liquid form of the formulations with appropriate amounts of the above mentioned powdery materials, such as fly ash, clays, silica, alumina, etc., to make the formulation into a free flowing powder, can be injected into the gas stream by utilizing any or combinations thereof of well known methods of injecting/blowing a powder. The powder of the invention should again be injected, between temperatures of 200 and 850° F. and prior to the particulate control/collection device or devices.

The methods of preparing the formulation of the composition and/or injecting the prepared formulation, whether in liquid or powder form, in the gas stream will be clear to those in the arts of making chemical formulations and in the application of chemical formulations.

The invention having been thus described, it will be obvious that the same may be varied in many ways without departing from the spirit and scope of the invention. All such modifications are intended to be included within the scope of the invention which is defined by the following claims.

I claim the following:

1. A formulation to remove mercury and other pollutants from a fluid stream at temperatures between 200 and 850° F. consisting of a mixture made by mixing together two groups of materials one selected from the group of bromide and iodide of ammonia, alkali, alkaline metals, and mixture thereof, and another selected from the group consisting of nitrate of ammonia, alkali metals, alkaline metals, base metals and mixture thereof.

2. A formulation to remove mercury and other pollutants present in a fluid stream consisting of a mixture made by mixing together two groups of materials one selected from the group of bromide and iodide of ammonia, alkali metals, alkaline metals, base metals, and mixture thereof, and another selected from the group consisting of polyhydroxy compounds, ammonium sulfate, and mixture thereof

3. A formulation as claimed in claim 1 above to remove mercury, other pollutants, and to condition the dust present in a fluid stream at temperatures between 200 and 850° F. for an enhanced removal of dust by an ESP.
